(19) United States
(12) Patent Application Publication
(10) Pub. No.: US 2014/0111447 A1
(43) Pub. Date: Apr. 24, 2014

(54) TOUCH SCREEN PANEL

(71) Applicant: SAMSUNG DISPLAY CO., LTD., Yongin-si (KR)

(72) Inventors: Seung-Heui Jeong, Yongin-si (KR); Hyoung-Wook Jang, Yongin-si (KR)

(73) Assignee: SAMSUNG DISPLAY CO., LTD., Yongin-si (KR)

(21) Appl. No.: 13/753,454

(22) Filed: Jan. 29, 2013

(30) Foreign Application Priority Data
Oct. 22, 2012 (KR) 10-2012-0117538

(51) Int. Cl. G06F 3/041

(52) U.S. Cl. CPC G06F 3/041
USPC 345/173

(57) ABSTRACT

There is provided a touch screen panel. The touch screen panel includes first electrodes, second electrodes and spacers. The first electrodes and second electrodes are arranged opposite to each other at an interval. Spacers are arranged between the first and second electrodes, and have at least two hardnesses.

### CROSS-REFERENCE TO RELATED APPLICATION

This application claims priority to and the benefit of Korean Patent Application No. 10-2012-0117538, filed on Oct. 22, 2012, in the Korean Intellectual Property Office, the entire content of which is incorporated herein by reference.

### BACKGROUND

1. Field

An aspect of the present invention relates to a touch screen panel.

2. Description of the Related Art

A touch screen panel is an input device that allows a user to input instructions with the user's hand or object by selecting an instruction content displayed on a screen of an image display or the like.

To this end, the touch screen panel is formed on a front face of the image display to convert a contact position into an electrical signal. Here, the user's hand or object is directly in contact with the touch screen panel at the contact position. Accordingly, the instruction content selected at the contact position is inputted as an input signal to the image display.

Since such a touch screen panel can be substituted for a separate input device connected to an image display, such as a keyboard or mouse, its application within different fields has been gradually expanding.

Touch screen panels can be divided into various categories, including resistive overlay touch screen panels, photosensitive touch screen panels, capacitive touch screen panels, and the like.

Among these touch screen panels, the capacitive touch screen panel senses a change in the capacitance of one conductive electrode formed with another electrode when an object such as a user's hand or stylus pen comes in contact with the touch screen panel, thereby converting the contact position into an electrical signal.

To this end, the capacitive touch screen panel has transmitting and receiving electrodes that are arranged opposite to each other at a predetermined interval so as to sense a change in mutual capacitance. Furthermore, spacers are provided between the transmitting and receiving electrodes. The touch sensitivity of the touch screen panel and the recovery speed after a touch to the touch screen panel are dependant on characteristics of the spacers. Hereinafter, this will be described in detail with reference to FIG. 1.

FIG. 1 is a graph comparing characteristics of high-hardness and low-hardness spacers, particularly displacements resulting from forces applied to the high-hardness and low-hardness spacers.

Referring to FIG. 1, the low-hardness spacers provide a sensitivity advantage in that a displacement is generated in response to even a small pressure. However, disadvantages of the low-hardness spacers are that when the pressure is removed, they require a long time to return to their original shape and the vertical displacement of the low-hardness spacers can become easily saturated in response to a high-pressure touch.

Meanwhile, the high-hardness spacers provide advantages in that they require a short time to return to their original shape and their vertical displacement can become saturated in response to a higher pressure than that which causes saturation of low-hardness spacers. However, a disadvantage of the high-hardness spacers is that a displacement is not generated or is minutely generated in response to a small pressure, and therefore, the touch sensitivity is decreased.

### SUMMARY

Embodiments provide for a touch screen panel which can have improved sensitivity and perform high-speed recovery and wide-range sensing.

Accordingly, in embodiments according to the present invention, a touch screen panel with spacers that can provide both high sensitivity and high-speed recovery, along with wide-range sensing, is provided.

According to an aspect of embodiments of the present invention, there is provided a touch screen panel, including: first electrodes and second electrodes, arranged opposite to each other at with a gap therebetween; and spacers arranged between the first and second electrodes, the spacers having at least two different hardnesses.

The spacers may include first spacers having a first hardness and second spacers having a second hardness different from the first hardness.

The first hardness may have a lower value than the second hardness, and a height of the first spacers may be greater than a height of the second spacers.

Upper and lower portions of the first spacers may contact with the first and second electrodes, respectively, and the second spacers may be formed so that upper portions of the second spacers are spaced apart from the first electrodes when the touch screen panel is in a state in which a touch input is not applied.

The first and second spacers may be arranged in dot patterns.

The spacers may include silicone material having rubber elasticity, and the first hardness maybe between about 15 Shore A and about 20 Shore A and the second hardness may be about 30 Shore A or more.

The touch screen panel may further include an elastic sheet positioned beneath the spacers. The elastic sheet may include a Poron® sheet.

The first and second electrodes may be arranged in a matrix form so as to detect coordinates of a touch input.

The first electrodes may be transmitting electrodes to which driving signals are applied, and the second electrodes may be receiving electrodes to which sensing signals are applied.

As described above, a plurality of spacers having different hardnesses may be alternately arranged between first and second electrodes arranged opposite to each other so that it is possible to implement a touch screen panel with improved sensitivity and that can recover at a high-speed while providing wide-range sensing.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a graph comparing characteristics between high-hardness and low-hardness spacers, particularly displacements according to forces applied to the high-hardness and low-hardness spacers.

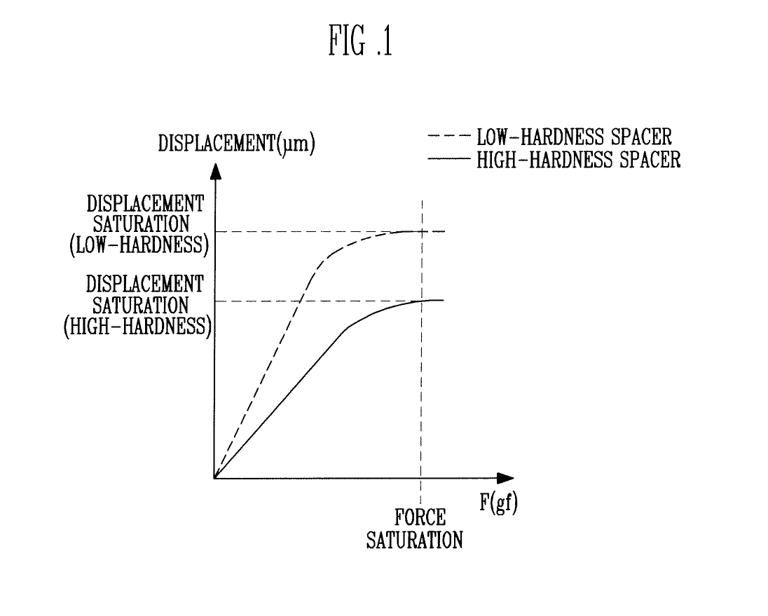

FIG. 2 is a plan view showing a touch screen panel according to an embodiment of the present invention.

FIGS. 3(a), 3(b), and 3(c) show schematic plan and side views illustrating a spacer structure in the touch screen panel according to an embodiment of the present invention.

FIGS. 4(a) and 4(b) show schematic plan and side views illustrating a spacer structure in the touch screen panel according to another embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

Hereinafter, exemplary embodiments of the present invention will be described in detail with reference to the accompanying drawings.

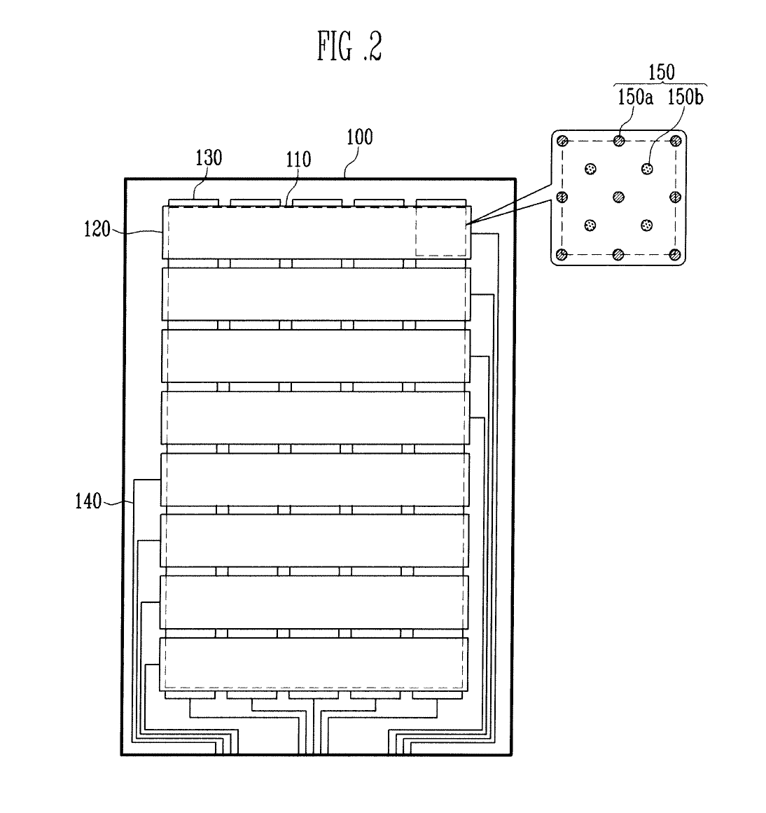

FIG. 2 is a plan view showing a touch screen panel according to an embodiment of the present invention.

Referring to FIG. 2, the touch screen panel 100 according to this embodiment includes a plurality of first electrodes 120 and a plurality of second electrodes 130 formed in a touch active area 110 so as to detect a touch position. Signal lines 140 connect the first and second electrodes 120 and 130 to an external driving circuit, sensing circuit, etc., and spacers 150 are arranged between the first and second electrodes 120 and 130.

The first and second electrodes 120 and 130 may be implemented, for example, as transparent electrodes. The first and second electrodes 120 and 130 may be arranged opposite to each other. The first and second electrodes 120 and 130 may be arranged in a matrix form so as to detect the coordinates of a touch position.

In a case where the touch screen panel is implemented as a mutual capacitive touch screen panel, the first electrodes 120 and the second electrodes 130 may be transmitting electrodes (Tx electrodes) to which driving signals are applied and receiving electrodes (Rx electrodes) to which sensing signals are applied, respectively.

If a touch input such as a user's finger or stylus pen comes in contact with the touch screen panel, a change in mutual capacitance between the first and second electrodes 120 and 130 is generated at the touch point. Accordingly, the change in mutual capacitance and its coordinates are sensed, thereby detecting the occurrence of a touch input and the position of the touch input.

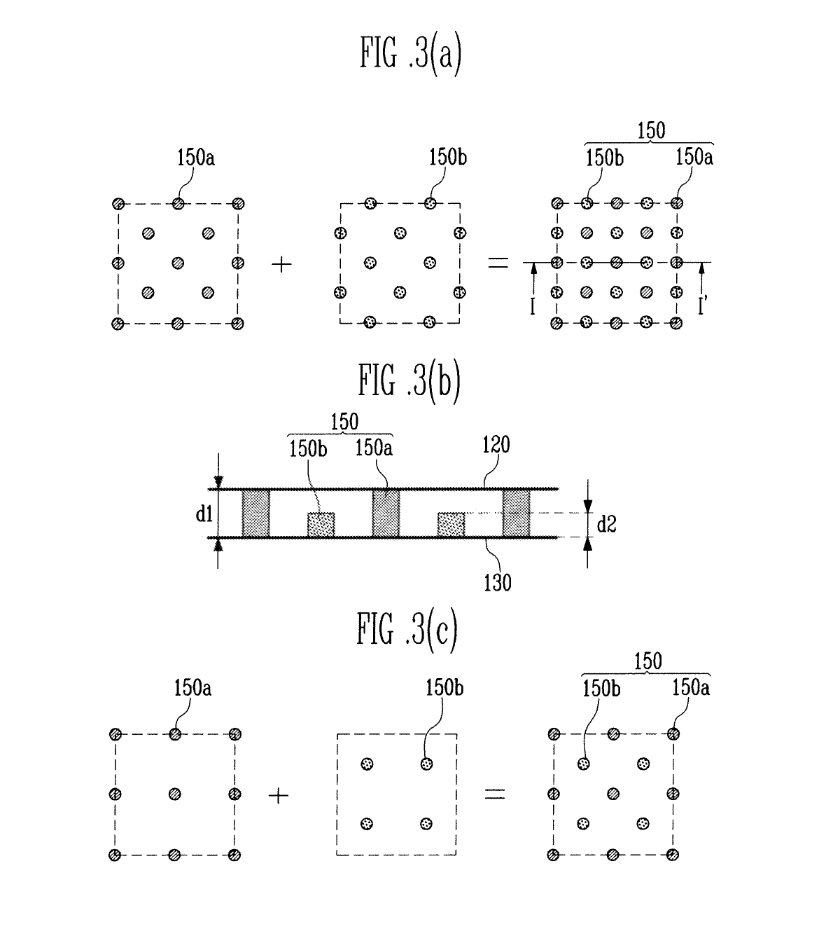

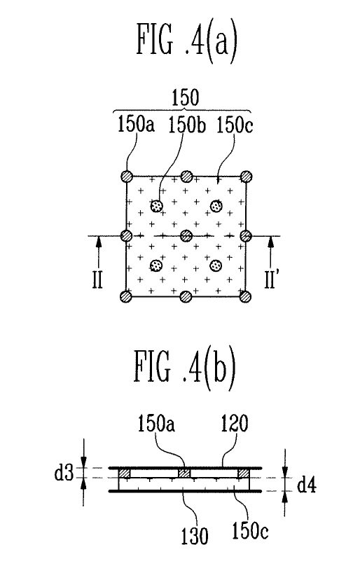

However, the touch sensitivity, sensing range and recovery speed of the touch screen panel 100 may be changed depending on characteristics of the spacers 150 arranged between the first and second electrodes 120 and 130. Accordingly, in this embodiment, a plurality of spacers 150a and 150b having different hardnesses are alternately arranged to provide improved sensitivity, high-speed recovery and wide-range sensing. Hereinafter, spacer structures of the touch screen panel according to this embodiment will be described in detail with reference to FIGS. 3 and 4.

FIGS. 3(a), 3(b), and 3(c) show schematic plan and side views illustrating a spacer structure in the touch screen panel according to an embodiment of the present invention.

Referring to FIGS. 3(a), 3(b), and 3(c), the spacer structure of the touch screen panel according to this embodiment includes at least two kinds of spacers 150a and 150b with at least two hardnesses and arranged between first and second electrodes 120 and 130.

To this end, the spacer structure of the touch screen panel according to this embodiment is implemented by a plurality of spacers 150. The plurality of spacers 150 includes the first spacers 150a having a first hardness and the second spacers 150b interposed amongst (or arranged between) the first spacers 150a and having a second hardness. The second hardness may be different from the first hardness. The first and second spacers 150a and 150b may be formed, for example, in dot patterns. However, the present invention is not limited thereto, and one of ordinary skill in the art would appreciate that the shape of the first spacers 150a and/or the second spacers 150b may be modified.

That is, the spacers 150 according to this embodiment include two kinds of spacers 150a and 150b alternately arranged as shown in FIG. 3(a). The first and second spacers 150a and 150b may be equally distributed between the upper and lower electrodes 120 and 130 in a touch active area. For example, the first and second spacers 150a and 150b may be equally distributed at regular intervals across a plane.

However, the first and second spacers 150a and 150b may be implemented so as to improve (or to optimize) the sensitivity and recovery speed of the touch screen panel. For example, the heights of the first and second spacers 150a and 150b may be set differently from each other.

Particularly, a low-hardness spacer may be formed higher than a high-hardness spacer. For example, when assuming that the first hardness of the first spacers 150a has a lower value than the second hardness of the second spacers 150b, the height d1 of the first spacers 150a, as shown in FIG. 3(b), may be set to be greater than the height d2 of the second spacers 150b.

FIG. 3(b) is a side sectional view taken along the line I-I′ of FIG. 3(a). Referring to FIG. 3(b), the height d1 of the first spacers 150a is greater than the height d2 of the second spacers 150b.

In an embodiment of the present invention, upper and lower portions of the first spacers 150a may come in contact with the first and second electrodes 120 and 130, respectively. The second spacers 150b may be positioned so that upper portions of the second spacers 150b are spaced apart from the upper electrode, i.e., a gap is formed between the first electrode 120 and the upper portions of the second spacers 150b when the touch screen panel is in a state in which a touch input is not applied.

The heights of the first and second spacers 150a and 150b may be modified or optimized in consideration of design conditions of the touch screen panel or characteristics of a desired sensitivity, etc. In one embodiment of the present invention, the height d2 of the second spacers 150b may be set to about one half of the height d1 of the first spacers 150a.

Meanwhile, although it has been illustrated in this embodiment that the first and second spacers 150a and 150b are respectively formed with single layers so as not to overlap with each other, the present invention is not limited thereto. In another embodiment of the present invention, the spacer structure of the touch screen panel may be implemented as a multi-layered structure in which the first and second spacers 150a and 150b are stacked.

In one embodiment, the material of the spacers 150a and 150b may be an insulation material having elasticity. For example, the spacers 150a and 150b may be formed of a silicone material having rubber elasticity. In another embodiment, the first hardness of the first spacers 150a, which is a low hardness, may be set to 15 to 20 Shore A, and the second hardness of the second spacers 150b may be set to no less than 30 Shore A. The first and second hardnesses of the first and second spacers 150a and 150b may be set in consideration of both the sensitivity and recovery speed of the touch screen panel. In one embodiment, where the first spacers 150a are formed of a material having a low hardness of less than 15 Shore A, e.g., a gel-type material, the first spacers 150a may exhibit improved sensitivity, but may provide diminished recovery speed. In one embodiment, the first hardness may be calibrated to 15 to 20 Shore A. In this embodiment, the second hardness of the second spacers 150b may be set to no less than 30 Shore A in order to increase the recovery speed.

In another embodiment, the concentration of the first and second spacers 150a and 150b may also be modified in consideration of design conditions of the touch screen panel or characteristics of a desired sensitivity, etc. For example, the spacers 150a and 150b may be distributed at wider intervals, as shown in FIG. 3(c).

The touch screen panel employing the spacer structure according to this embodiment as described above may be highly sensitively driven by using first spacers 150a having the low hardness. Further, in the touch screen panel according to this embodiment, the high-speed recovery is possible by arranging the second spacers 150b amongst the first spacers 150a, while the wide-range sensing for a touch input is possible by using the first and second spacers 150a and 150b together.

FIGS. 4(a) and 4(b) show schematic plan and side views illustrating a spacer structure in the touch screen panel according to another embodiment of the present invention.

Referring to FIGS. 4(a) and 4(b), the spacer structure of the touch screen panel according to this embodiment may further include an elastic sheet 150c positioned beneath the first and second spacers 150a and 150b. That is, the elastic sheet 150c is disposed between the lower electrode (second electrode) 130 and the spacers 150a and 150b. The height d3 of the spacers 150a and 150b and the height d4 of the elastic sheet 150c may also be modified (or optimized) in consideration of design conditions such as the interval between the upper and lower electrodes 120 and 130, the sensitivity, etc.

In an embodiment, the elastic sheet 150c may be implemented as any polymer material (e.g., urethane) such as a Poron® sheet. Poron® is a registered trademark of World Properties Inc., Lincolnwood, Ill. The Poron® sheet provides a slightly hard feeling with instantaneous impact absorption and high reactivity.

The spacer structure of the touch screen panel according to this embodiment is implemented as a multi-layered structure in which the elastic sheet 150c and the upper spacers with different hardnesses 150a and 150b are stacked. Further, the touch screen panel according to this embodiment may have high sensitivity and perform high-speed recovery and wide-range sensing.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A touch screen panel, comprising:
first electrodes and second electrodes, arranged opposite to each other with a gap therebetween; and
spacers arranged between the first and second electrodes, the spacers having at least two different hardnesses.

2. The touch screen panel of claim 1, wherein the spacers comprise first spacers having a first hardness and second spacers having a second hardness different from the first hardness.

3. The touch screen panel of claim 2, wherein the first hardness has a lower value than the second hardness, and a height of the first spacers is greater than a height of the second spacers.

4. The touch screen panel of claim 3, wherein upper and lower portions of the first spacers contact with the first and second electrodes, respectively, and the second spacers are formed so that upper portions of the second spacers are spaced apart from the first electrodes when the touch screen panel is in a state in which a touch input is not applied.

5. The touch screen panel of claim 2, wherein the first and second spacers are arranged in dot patterns.

6. The touch screen panel of claim 2, wherein the spacers comprise silicone material having rubber elasticity, and the first hardness is between about 15 Shore A and about 20 Shore A and the second hardness is about 30 Shore A or more.

7. The touch screen panel of claim 1, further comprising an elastic sheet positioned beneath the spacers.

8. The touch screen panel of claim 7, wherein the elastic sheet comprises a Poron sheet.

9. The touch screen panel of claim 1, wherein the first and second electrodes are arranged in a matrix form so as to detect coordinates of a touch input.

10. The touch screen panel of claim 1, wherein the first electrodes are transmitting electrodes to which driving signals are applied, and the second electrodes are receiving electrodes to which sensing signals are applied.
